(19) United States
(12) Patent Application Publication
(10) Pub. No.: US 2007/0077412 A1
(43) Pub. Date: Apr. 5, 2007

(54) Ultraviolet resistant coating for articles

(75) Inventor: Ga-Lane Chen, Fremont, CA (US)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/411,625

(22) Filed: Apr. 26, 2006

(30) Foreign Application Priority Data
Sep. 30, 2005 (CN) 200510100112.5

(51) Int. Cl. B32B 27/08; B32B 27/38; B32B 5/16; B32B 27/36; B32B 27/30

(52) U.S. Cl. 428/323; 428/480; 428/414; 428/335; 428/336; 428/522; 428/447; 428/328; 428/329; 428/457

(57) ABSTRACT

A coating system (100) for an article is provided. The coating system includes a primer coating (110) mainly composed of a resin, a top coating (120) composed of 85˜99% by weight of a resin matrix and 1˜15% by weight of nano-oxide particles (122) for absorbing ultraviolet radiation. The primer coating is coated on a surface of the article. The top coating is coated on the primer coating and provides protection for the primer coating from ultraviolet radiation. Therefore, the coating system is prevented from peeling-off, and has a lengthened service lifetime.

### BACKGROUND OF THE INVENTION

1. Technical Field

The present invention relates to coating systems for articles of manufacture, and more particularly to a multi-layered coating system having ultraviolet resistance property.

2. Discussion of the Related Art

Industrial products, such as communication, computer and consumer products, are in increasing demand in modern society. For example, mobile phones, notebook computers, MP3, personal digital assistants (PDA), etc., become more and more popular recently. These products, among others, generally require a rigid and durable outer shell, which could be made from plastic, metals, magnesium alloy, and aluminum alloy. Generally, the outer shells of the products further require a coating that protects such products from damage effects of abrasion, scratch, corrosion, etc. Conventional coatings are mainly composed of resins. Advantageously, resin coatings have a high density and wear resistance. However, resins are likely to be aged and degraded when expose to ultraviolet radiation, and the coatings composed of resins are apt to be peeled off accordingly.

Therefore, what is needed is a coating system having a good wear resistance and an improved resistance to ultraviolet radiation.

### SUMMARY

An embodiment of the present invention provides a coating system for an article, which includes a primer coating mainly composed of a wear resistant resin, a top coating composed of 85˜99% by weight of a resin matrix and 1˜15% by weight of nano-oxide particles for absorbing ultraviolet radiation. The primer coating is coated on a surface of the article. The top coating is coated on the primer coating and provides protection for the primer coating from ultraviolet radiation.

Other systems, methods, features, and advantages will be or become apparent to one skilled in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

FIG. 1 is a schematic, cross-sectional view of a coating structure according to a preferred embodiment.

### DETAILED DESCRIPTION OF THE PREFERRED EMBODIMENTS

Reference will now be made to the drawings to describe preferred embodiments of the present invention in detail.

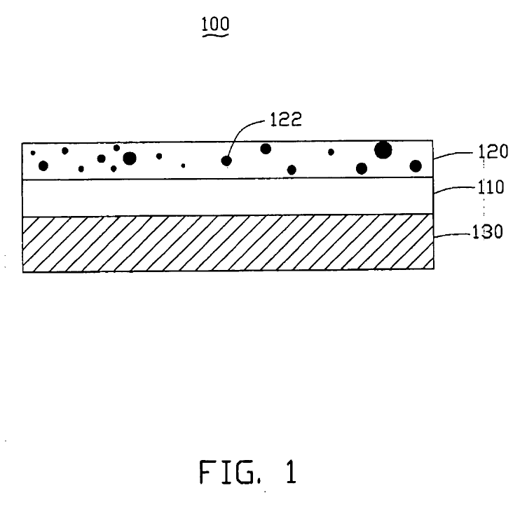

Referring to FIG. 1, a coating system 100 for an article according to an embodiment is shown. The coating system 100, which is applied to a substrate 130 of the article, includes a primer layer 110 coated on a surface the substrate 130, and a top coating 120 coated on the primer layer 110.

The primer layer 110 is composed of a wear resistant resin, such as epoxy resin, bisphenol resin, and polyester resin. Preferably, a thickness of the primer layer 110 is in a range from 10 microns to 30 microns.

The top coating 120 is composed of 85˜99% by weight of resin matrix and 1˜15% by weight of nano-oxide particles 122 distributed in the resin matrix. Preferably, the top coating 120 is composed of 98˜99% by weight of resin matrix and 1˜2% by weight of nano-oxide particles. A thickness of the top coating 120 is in a range from 5 microns to 25 microns.

The resin matrix for the top coating 120 is preferably silicon resin or acrylic resin. The nano-oxide particles 122 can be nano-titanium oxide, nano-zinc oxide, nano-aluminum oxide, nano-silicon oxide, or a combination thereof. A grain size for the nano-oxide particles 122 is preferably in a range from 20 nanometers to 200 nanometers.

The substrate 130 can be made of metals, plastics and alloys, such as magnesium alloy, aluminum alloy, and iron-based alloy which is widely used in mobile phones, notebook computers, and other industrial products.

It is understood that the nano-oxide particles 122 distributed in the resin matrix of the top coating 120 can absorb ultraviolet ray, therefore, the primer layer 110 of the present coating system 100 is protected from ultraviolet radiation, and the coating system 100 is prevent from peeling-off. In addition to the absorbing of ultraviolet radiation, nano-titanium oxide and nano-zinc oxide particles are good photo-catalytic material, and have advantages of bacteria killing, removal of odor, and sterilization. Furthermore, the nano-aluminum oxide particles can improve a mechanical strength of the coating system 100.

Compared with conventional coating system, the present coating system 100 contains a top coating layer for absorbing ultraviolet, and the primer coating is protected from ultraviolet radiation. Therefore, peeling-off and degradation of the coating system caused by unduly ultraviolet radiation are prevented, and a service life of the coating system is lengthened.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A coating system, comprising:
a primer coating composed of a wear resistant resin;
a top coating coated on the primer coating;
the top coating is composed of 85%˜99% by weight of a resin matrix and 1%˜15% by weight of an ultraviolet absorber nano-oxide particle distributed therein.

2. The coating system as described in claim 1, wherein the resin of the primer coating is one of a group consisting of epoxy resin, bisphenol resin and polyester resin.

3. The coating system as described in claim 2, wherein a thickness of the primer coating is in the range from 10 microns to 30 microns.

4. The coating system as described in claim 1, wherein a thickness of the top coating is in the range from 5 microns to 25 microns.

5. The coating system as described in claim 1, wherein the resin matrix is one of a group consisting of silicon resin and acrylic resin.

6. The coating system as described in claim 1, the ultraviolet absorber nano-oxide particles comprise nano-titanium oxide, nano-zinc oxide, nano-aluminum oxide, nano-silicon oxide and a combination thereof.

7. The coating system as described in claim 1, wherein a grain size of the ultraviolet absorber nano-particles is in the range from 20 nanometers to 200 nanometers.

8. The coating system as described in claim 1, wherein the coating system comprising a substrate, and the primer coating is coated on a surface of the substrate.

9. The coating system as described in claim 8, wherein the substrate comprises metals, plastic material, and metallic alloys.

10. An article, comprising:
a substrate having a surface;
a primer coating adhered on the surface of the substrate;
a top coating coated on the primer coating;
the primer coating is comprised of a resin;
the top coating is comprised of 85%˜99% by weight of a resin matrix and 1%˜15% by weight of a nano-oxide particle distributed therein for preventing ultraviolet radiation onto the primer coating.

11. The article as described in claim 10, wherein the resin is one of a group consisting of epoxy resin, bisphenol resin and polyester resin.

12. The article as described in claim 10, wherein the nano-oxide particle comprise one of a group consisting of nano-titanium oxide, nano-zinc oxide, nano-aluminum oxide, nano-silicon oxide and a combination thereof.

13. The article as described in claim 12, wherein a grain size of the nano-oxide particle is in a range from 20 nanometers to 200 nanometers.

14. The article as described in claim 10, wherein the substrate is comprised of metals, plastic material, and metallic alloys.

15. The article as described in claim 14, wherein the alloys comprise magnesium alloy, aluminum alloy, and iron-based alloy.

16. The article as described in claim 10, wherein the article is a mobile phone.

17. The article as described in claim 10, wherein the article is a notebook computer.
